(19) United States
(12) Patent Application Publication
(10) Pub. No.: US 2016/0098190 A1
(43) Pub. Date: Apr. 7, 2016

(54) Intelligent Terminal and Method for Displaying Input Operation Interface Thereof

(71) Applicant: Huawei Technologies Co., Ltd., Shenzhen (CN)

(72) Inventors: Haizhao Lu, Shenzhen (CN); Zhangquan Zhao, Shenzhen (CN)

(21) Appl. No.: 14/967,535

(22) Filed: Dec. 14, 2015

Related U.S. Application Data
(63) Continuation of application No. PCT/CN2013/086780, filed on Nov. 8, 2013.

(51) Int. Cl. G06F 3/0488

(52) U.S. Cl. CPC G06F 3/04886

(57) ABSTRACT

An intelligent terminal and a method for displaying an input operation interface thereof are disclosed, where the method includes determining whether a user performs an input operation on the input operation interface of the intelligent terminal using a right hand or a left hand; if a result of determining is that the user performs the input operation using the right hand, setting input keys, which are on the input operation interface, to be arranged from right to left according to a preset rule; and if a result of determining is that the user performs the input operation using the left hand, setting the input keys, which are on the input operation interface, to be arranged from left to right according to the preset rule.

### CROSS-REFERENCE TO RELATED APPLICATIONS

This application is a continuation of International Application No. PCT/CN2013/086780, filed on Nov. 8, 2013, which is hereby incorporated by reference in its entirety.

### TECHNICAL FIELD

The present disclosure relates to the field of intelligent terminals, and in particular, to an intelligent terminal and a method for displaying an input operation interface thereof.

### BACKGROUND

An intelligent terminal gradually becomes a necessary communications tool of people. To improve visual experience of a user, a handheld intelligent terminal with a super large screen becomes a development trend. A 4.5-inch screen has become a mainstream configuration for a flagship model, while a 4.7-inch or a 5.0-inch screen is going to become a screen configuration for a flagship model of a next-generation intelligent terminal.

Generally, an input method of an intelligent terminal supports dynamic adjustment of an arrangement sequence of words, that is, performing an intelligent ranking according to frequency of use of the words, so as to place the most commonly used word on the top of candidate words. For example, the words are successively arranged from left to right and from top to bottom according to the frequency of use from high to low, so that the user can select a desired word easily.

A handheld terminal has a relatively large screen, and candidate words are usually arranged from left to right, that is, the most commonly used word is generally placed in the leftmost position. Therefore, when a user holds a mobile phone with a right hand, it is not easy for a thumb of the right hand to reach the leftmost position, which brings inconvenience to the user.

### SUMMARY

In view of this, a technical problem to be resolved in the present disclosure is how to optimize an input operation interface of an intelligent terminal so as to improve input experience of a user.

To resolve the foregoing technical problem, an embodiment of the present disclosure provides a method for displaying an input operation interface of an intelligent terminal, including determining whether a user performs an input operation on the input operation interface of the intelligent terminal using a right hand or a left hand; if a result of determining is that the user performs the input operation using the right hand, setting input keys, which are on the input operation interface, to be arranged from right to left according to a preset rule; and if a result of determining is that the user performs the input operation using the left hand, setting the input keys, which are on the input operation interface, to be arranged from left to right according to the preset rule.

With reference to the foregoing method for displaying an input operation interface of an intelligent terminal, in a possible implementation manner, the determining whether a user performs an input operation on the input operation interface of the intelligent terminal using a right hand or a left hand includes determining, on a basis of a touch time interval of a key, whether the user performs the input operation using the right hand or the left hand, where the key is located on the input operation interface, and the touch time interval of the key indicates a time interval between a previous touch and a current touch of the key.

With reference to the foregoing method for displaying an input operation interface of an intelligent terminal, in a possible implementation manner, the determining, on a basis of a touch time interval of a key, whether the user performs the input operation using the right hand or the left hand includes collecting, in a preset length of time, statistics about a first touch time interval and a second touch time interval, where the first touch time interval indicates an average value of a touch time interval of at least one key on a left side of the input operation interface, and the second touch time interval indicates an average value of a touch time interval of at least one key on a right side of the input operation interface; if the first touch time interval is less than the second touch time interval, determining that the user performs the input operation using the left hand; and if the first touch time interval is greater than or equal to the second touch time interval, determining that the user performs the input operation using the right hand.

With reference to the foregoing method for displaying an input operation interface of an intelligent terminal, in a possible implementation manner, the determining whether a user performs an input operation on the input operation interface of the intelligent terminal using a right hand or a left hand includes determining, on a basis of a probability at which a sub-area of a key is touched, whether the user performs the input operation using the right hand or the left hand, where the key is located on the input operation interface, the sub-area indicates a part on an upper left side, a lower left side, an upper right side, a lower right side, a left side, or a right side of the key, and the probability at which the sub-area of the key is touched indicates a proportion of a quantity of times the sub-area is touched in a total quantity of times the key is touched.

With reference to the foregoing method for displaying an input operation interface of an intelligent terminal, in a possible implementation manner, the determining, on a basis of a probability at which a sub-area of a key is touched, whether the user performs the input operation using the right hand or the left hand includes collecting, in a preset length of time, statistics about a first touch probability and a second touch probability, where the first touch probability indicates a probability at which a lower left sub-area of a key on an upper right side of the input operation interface is touched, and the second touch probability indicates a probability at which a lower right sub-area of a key on an upper left side of the input operation interface is touched; if the first touch probability is greater than or equal to the second touch probability, determining that the user performs the input operation using the left hand; and if the first touch probability is less than the second touch probability, determining that the user performs the input operation using the right hand.

With reference to the foregoing method for displaying an input operation interface of an intelligent terminal, in a possible implementation manner, the determining, on a basis of a probability at which a sub-area of a key is touched, whether the user performs the input operation using the right hand or the left hand includes collecting, in a preset length of time, statistics about a first touch probability and a second touch probability, where the first touch probability indicates a probability at which a left-side sub-area of a key on a lower right side of the input operation interface is touched, and the second touch probability indicates a probability at which a right-side sub-area of a key on a lower left side of the input operation interface is touched; if the first touch probability is greater than or equal to the second touch probability, determining that the user performs the input operation using the left hand; and if the first touch probability is less than the second touch probability, determining that the user performs the input operation using the right hand.

With reference to the foregoing method for displaying an input operation interface of an intelligent terminal, in a possible implementation manner, the determining, on a basis of a probability at which a sub-area of a key is touched, whether the user performs the input operation using the right hand or the left hand includes collecting, in a preset length of time, statistics about a first touch probability, a second touch probability, a third touch probability, and a fourth touch probability, where the first touch probability indicates an average value of a probability at which right-side sub-areas of at least two keys on a left side of the input operation interface are touched, the second touch probability indicates an average value of a probability at which left-side sub-areas of at least two keys on the left side are touched, the third touch probability indicates an average value of a probability at which right-side sub-areas of at least two keys on a right side of the input operation interface are touched, and the fourth touch probability indicates an average value of a probability at which left-side sub-areas of at least two keys on the right side are touched; calculating a left-side touch probability difference and a right-side touch probability difference, where the left-side touch probability difference equals a value obtained by subtracting the second touch probability from the first touch probability, and the right-side touch probability difference equals a value obtained by subtracting the fourth touch probability from the third touch probability; and if the left-side touch probability difference is greater than or equal to a first threshold and the right-side touch probability difference is less than a second threshold, determining that the user performs the input operation using the right hand.

With reference to the foregoing method for displaying an input operation interface of an intelligent terminal, in a possible implementation manner, the input keys include at least one of the following: a candidate word key, a punctuation mark key, a numeric key, and a regular key.

With reference to the foregoing method for displaying an input operation interface of an intelligent terminal, in a possible implementation manner, the preset rule includes at least one of the following: a probability of use, a user preference, and network term frequency.

To resolve the foregoing technical problem, an embodiment of the present disclosure provides an intelligent terminal, including a determining module configured to determine whether a user performs an input operation on an input operation interface of the intelligent terminal using a right hand or a left hand; and a setting module connected to the determining module and configured to, if a result of determining is that the user performs the input operation using the right hand, set input keys, which are on the input operation interface, to be arranged from right to left according to a preset rule; and if a result of determining is that the user performs the input operation using the left hand, set the input keys, which are on the input operation interface, to be arranged from left to right according to the preset rule.

With reference to the intelligent terminal, in a possible implementation manner, the determining module includes a first determining unit configured to determine, on a basis of a touch time interval of a key, whether the user performs the input operation using the right hand or the left hand, where the key is located on the input operation interface, and the touch time interval of the key indicates a time interval between a previous touch and a current touch of the key.

With reference to the foregoing intelligent terminal, in a possible implementation manner, the determining module further includes a first calculating unit connected to the first determining unit, where the first calculating unit is configured to collect, in a preset length of time, statistics about a first touch time interval and a second touch time interval, where the first touch time interval indicates an average value of a touch time interval of at least one key on a left side of the input operation interface, and the second touch time interval indicates an average value of a touch time interval of at least one key on a right side of the input operation interface; and the first determining unit is configured to compare the first touch time interval with the second touch time interval; if the first touch time interval is less than the second touch time interval, determine that the user performs the input operation using the left hand; and if the first touch time interval is greater than or equal to the second touch time interval, determine that the user performs the input operation using the right hand.

With reference to the foregoing intelligent terminal, in a possible implementation manner, the determining module includes a second determining unit configured to determine, on a basis of a probability at which a sub-area of a key is touched, whether the user performs the input operation using the right hand or the left hand, where the key is located on the input operation interface, the sub-area indicates a part on an upper left side, a lower left side, an upper right side, a lower right side, a left side, or a right side of the key, and the probability at which the sub-area of the key is touched indicates a proportion of a quantity of times the sub-area is touched in a total quantity of times the key is touched.

With reference to the foregoing intelligent terminal, in a possible implementation manner, the determining module further includes a second calculating unit connected to the second determining unit, where the second calculating unit is configured to collect, in a preset length of time, statistics about a first touch probability and a second touch probability, where the first touch probability indicates a probability at which a lower left sub-area of a key on an upper right side of the input operation interface is touched, and the second touch probability indicates a probability at which a lower right sub-area of a key on an upper left side of the input operation interface is touched; and the second determining unit is configured to compare the first touch probability with the second touch probability; if the first touch probability is greater than or equal to the second touch probability, determine that the user performs the input operation using the left hand; and if the first touch probability is less than the second touch probability, determine that the user performs the input operation using the right hand.

With reference to the foregoing intelligent terminal, in a possible implementation manner, the second calculating unit is further configured to collect, in a preset length of time, statistics about a first touch probability and a second touch probability, where the first touch probability indicates a probability at which a left-side sub-area of a key on a lower right side of the input operation interface is touched, and the second touch probability indicates a probability at which a right-side sub-area of a key on a lower left side of the input operation interface is touched.

With reference to the foregoing intelligent terminal, in a possible implementation manner, the second calculating unit is further configured to collect, in a preset length of time, statistics about a first touch probability, a second touch probability, a third touch probability, and a fourth touch probability, where the first touch probability indicates an average value of a probability at which right-side sub-areas of at least two keys on a left side of the input operation interface are touched, the second touch probability indicates an average value of a probability at which left-side sub-areas of at least two keys on the left side are touched, the third touch probability indicates an average value of a probability at which right-side sub-areas of at least two keys on a right side of the input operation interface are touched, and the fourth touch probability indicates an average value of a probability at which left-side sub-areas of at least two keys on the right side are touched; and calculate a left-side touch probability difference and a right-side touch probability difference, where the left-side touch probability difference equals a value obtained by subtracting the second touch probability from the first touch probability, and the right-side touch probability difference equals a value obtained by subtracting the fourth touch probability from the third touch probability; and the second determining unit is configured to compare the left-side touch probability difference with a first threshold, and the right-side touch probability difference with a second threshold; and if the left-side touch probability difference is greater than or equal to the first threshold and the right-side touch probability difference is less than the second threshold, determine that the user performs the input operation using the right hand.

With reference to the foregoing intelligent terminal, in a possible implementation manner, the input keys include at least one of the following: a candidate word key, a punctuation mark key, a numeric key, and a regular key.

With reference to the foregoing intelligent terminal, in a possible implementation manner, the preset rule includes at least one of the following: a probability of use, a user preference, and network term frequency.

### Beneficial Effect

According to the intelligent terminal and the method for displaying an input operation interface thereof in the embodiments of the present disclosure, whether a user performs an input operation on the input operation interface of the intelligent terminal using a right hand or a left hand is determined, and then a sequence of input keys on the input operation interface is adjusted according to a result of determining, such that the user can easily extend a finger of the user on a large screen, which greatly increases an input speed of the user and improves user experience.

Exemplary embodiments are described in detail with reference to accompanying drawings in the following to make other features and aspects of the present disclosure clear.

### BRIEF DESCRIPTION OF DRAWINGS

Accompanying drawings included in the specification and constituting a part of the specification and the specification illustrate exemplary embodiments, features, and aspects of the present disclosure, and are used for explaining principles of the present disclosure.

FIG. 1 is a flowchart of a method for displaying an input operation interface of an intelligent terminal according to an embodiment of the present disclosure;

FIG. 2 is a flowchart of a method for displaying an input operation interface of an intelligent terminal according to another embodiment of the present disclosure;

FIG. 3 is a schematic diagram of a 9-key input operation interface;

FIG. 4 is a flowchart of a method for displaying an input operation interface of an intelligent terminal according to still another embodiment of the present disclosure;

FIG. 5 is a schematic diagram of dividing an input key on a 9-key input operation interface into sub-areas;

FIG. 6 is a flowchart of a method for displaying an input operation interface of an intelligent terminal according to still another embodiment of the present disclosure;

FIG. 7 is a structural block diagram of an intelligent terminal according to an embodiment of the present disclosure;

FIG. 8 is a structural block diagram of an intelligent terminal according to another embodiment of the present disclosure; and

FIG. 9 is a schematic structural diagram of an intelligent terminal according to still another embodiment of the present disclosure.

### DESCRIPTION OF EMBODIMENTS

Various exemplary embodiments, features, and aspects of the present disclosure are described in detail hereinafter with reference to accompanying drawings. In the drawings, identical reference numerals denote elements that have an identical or similar function. Although various aspects of the embodiments are shown in the drawings, unless otherwise specified, the drawings are not necessarily drawn to scale.

The specific term “exemplary” herein means “used as an example, embodiment or illustrative”. Any embodiment described as “exemplary” is not necessarily explained as being superior or better than other embodiments.

In addition, to better describe the present disclosure, many details are given in the following implementation manners. A person of ordinary skill in the art should understand that the present disclosure may also be implemented without the specific details. In some other embodiments, methods, means, components, and circuits well known by a person skilled in the art are not described in detail, such that a main purpose of the present disclosure is highlighted.

### Embodiment 1

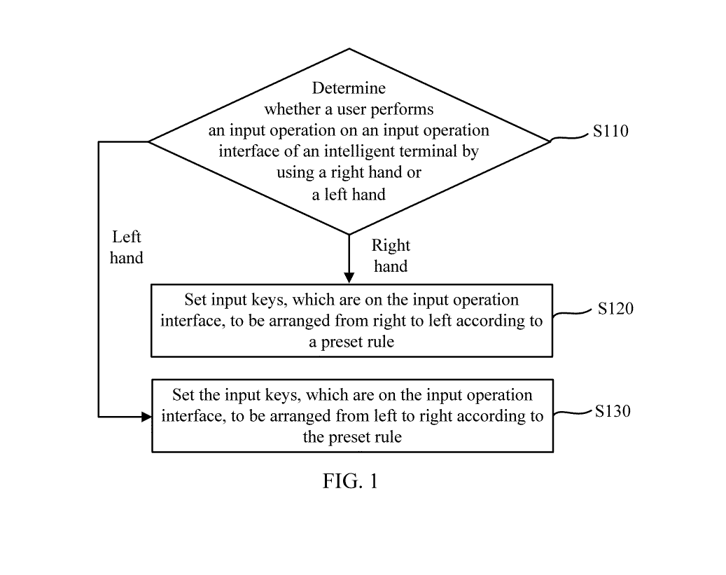

FIG. 1 is a flowchart of a method for displaying an input operation interface of an intelligent terminal according to an embodiment of the present disclosure. As shown in FIG. 1, the method mainly includes the following steps.

S110. Determine whether a user performs an input operation on the input operation interface of the intelligent terminal using a right hand or a left hand.

Generally, time needed in reaching a distant key by extending a thumb and time for accurately positioning the key are longer than time needed in reaching a near key by extending the thumb and time for accurately positioning the key. Therefore, in a possible implementation manner, whether the user performs the input operation using the right hand or the left hand may be determined on a basis of a touch time interval of a key, where the key is located on the input operation interface, and the touch time interval of the key indicates a time interval between a previous touch and a current touch of the key.

In addition, when the thumb presses a key in a different area, generally, limited by a length of the thumb, the thumb may press an edge of the key. Therefore, in another possible implementation manner, whether the user performs the input operation on the input operation interface of the intelligent terminal using the right hand or the left hand may also be determined on a basis of a probability at which a sub-area of the key is touched, where the sub-area indicates a part on an upper left side, a lower left side, an upper right side, a lower right side, a left side, or a right side of the key, and the probability at which the sub-area of the key is touched indicates a proportion of a quantity of times the sub-area is touched in a total quantity of times the key is touched.

S120. If a result of determining is that the user performs the input operation using the right hand, set input keys, which are on the input operation interface, to be arranged from right to left according to a preset rule.

S130. If a result of determining is that the user performs the input operation using the left hand, set the input keys, which are on the input operation interface, to be arranged from left to right according to the preset rule.

In a possible implementation manner, the input keys may include at least one of the following: a candidate word key, a punctuation mark key, a numeric key, and a regular key.

In a possible implementation manner, the preset rule may include at least one of the following: a probability of use, a user preference, and network term frequency. The input keys may be arranged according to the probability of use from high to low and on a basis of the foregoing determination result, and an arrangement sequence of the input keys may also be correspondingly adjusted in a case of a different determination result according to a personal preference of the user. In addition, if the intelligent terminal is connected to a network, a candidate word recommended by the network may also be arranged to be near to a finger by which the user performs the input operation.

Therefore, according to the method for displaying an input operation interface of an intelligent terminal in this embodiment, a sequence of input keys on the input operation interface is adjusted according to a result of determining whether a user performs an input operation on the input operation interface of the intelligent terminal using a right hand or a left hand, such that the user can easily extend a finger of the user on a large screen, which greatly increases an input speed of the user and improves user experience.

### Embodiment 2

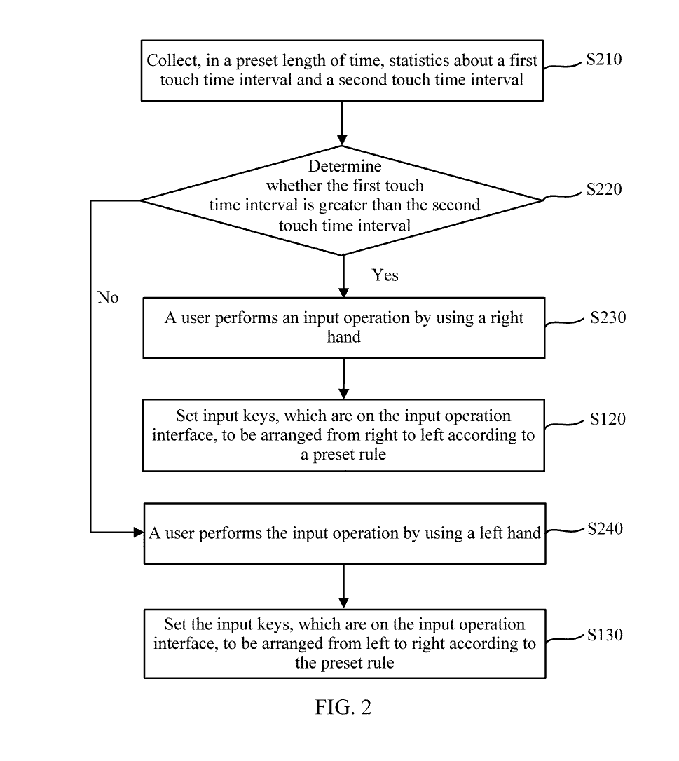

FIG. 2 is a flowchart of a method for displaying an input operation interface of an intelligent terminal according to another embodiment of the present disclosure. A component in FIG. 2 that has a same reference numeral as that in FIG. 1 has a same function. For brevity, a detailed description of these components is omitted.

As shown in FIG. 2, a main difference between the method for displaying an input operation interface of an intelligent terminal shown in FIG. 2 and the method for displaying an input operation interface of an intelligent terminal shown in FIG. 1 is that, in a possible implementation manner, operation steps of step S110 in Embodiment 1 may be the following steps.

S210. Collect, in a preset length of time, statistics about a first touch time interval and a second touch time interval. In a possible implementation manner, the first touch time interval may indicate an average value of a touch time interval of at least one key on a left side of the input operation interface, and the second touch time interval may indicate an average value of a touch time interval of at least one key on a right side of the input operation interface.

S220. Determine whether the first touch time interval is greater than or equal to the second touch time interval.

S230. If the first touch time interval is greater than or equal to the second touch time interval, determine that the user performs the input operation using the right hand.

S240. If the first touch time interval is less than the second touch time interval, determine that the user performs the input operation using the left hand.

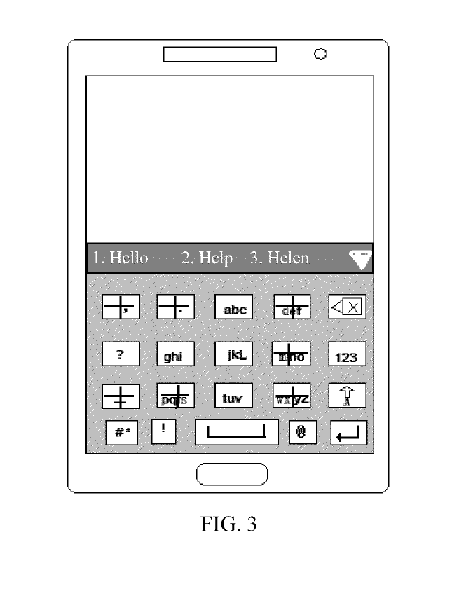

Statistics about the touch time interval of the key may be collected in the preset length of time. That is, statistics about a time interval between the first touch of the key and the second touch of the key that are in the preset length of time are collected, statistics about a time interval between the second touch of the key and the third touch of the key are collected, and by analogy, statistics about a time interval between the second-to-last touch of the key and the last touch of the key that are in the preset length of time are collected. Then, a length of a touch time interval of a key in a different position of the input operation interface is analyzed. A 9-key input operation interface shown in FIG. 3 is used as an example. If an average touch time interval of keys, such as “,”, “ghi”, and “pqrs”, on a left side of the 9-key input operation interface is less than an average touch time interval of keys, such as “def”, “mno”, and “wxyz”, on a right side of the 9-key input operation interface, it is determined that the user performs the input operation using the left hand. If the former average touch time interval is greater than or equal to the latter average touch time interval, it is determined that the user performs the input operation using the right hand.

It should be noted that, if a time interval between a key press and a next key press exceeds a preset time threshold, for example, 30 seconds, the next key press is used as a first key press in another preset length of time. Preferably, for more convenient use of a 9-key input method by the user, an arrangement sequence of a candidate word is adjusted only once in one preset length of time.

Therefore, according to the method for displaying an input operation interface of an intelligent terminal in this embodiment, whether a user performs an input operation using a right hand or a left hand is determined on a basis of a touch time interval of a key, and then a sequence of input keys on the input operation interface is adjusted according to a result of determining, such that the user can easily extend a finger of the user on a large screen, which greatly increases an input speed of the user and improves user experience.

### Embodiment 3

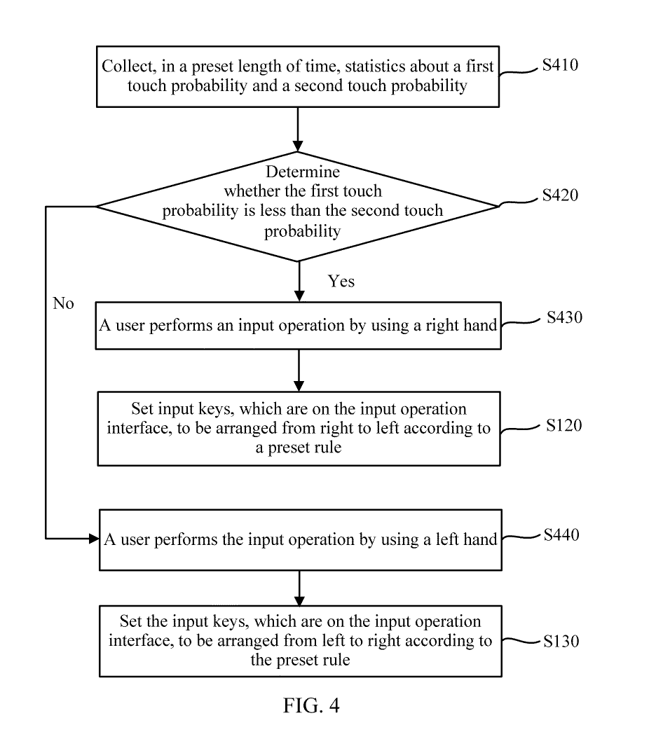

FIG. 4 is a flowchart of a method for displaying an input operation interface of an intelligent terminal according to still another embodiment of the present disclosure. A component in FIG. 4 that has a same reference numeral as that in FIG. 1 has a same function. For brevity, a detailed description of these components is omitted.

As shown in FIG. 4, a main difference between the method for displaying an input operation interface of an intelligent terminal shown in FIG. 4 and the method for displaying an input operation interface of an intelligent terminal shown in FIG. 1 is that, in a possible implementation manner, operation steps of step S110 in Embodiment 1 may further be the following steps.

S410. Collect, in a preset length of time, statistics about a first touch probability and a second touch probability. In a possible implementation manner, the first touch probability may indicate a probability at which a lower left sub-area of a key on an upper right side of the input operation interface is touched, and the second touch time interval may indicate a probability at which a lower right sub-area of a key on an upper left side of the input operation interface is touched.

In another possible implementation manner, the first touch probability may indicate a probability at which a left-side sub-area of a key on a lower right side of the input operation interface is touched, and the second touch probability may indicate a probability at which a right-side sub-area of a key on a lower left side of the input operation interface is touched.

S420. Determine whether the first touch probability is less than the second touch probability.

S430. If the first touch probability is less than the second touch probability, determine that the user performs the input operation using the right hand.

S440. If the first touch probability is greater than or equal to the second touch probability, determine that the user performs the input operation using the left hand.

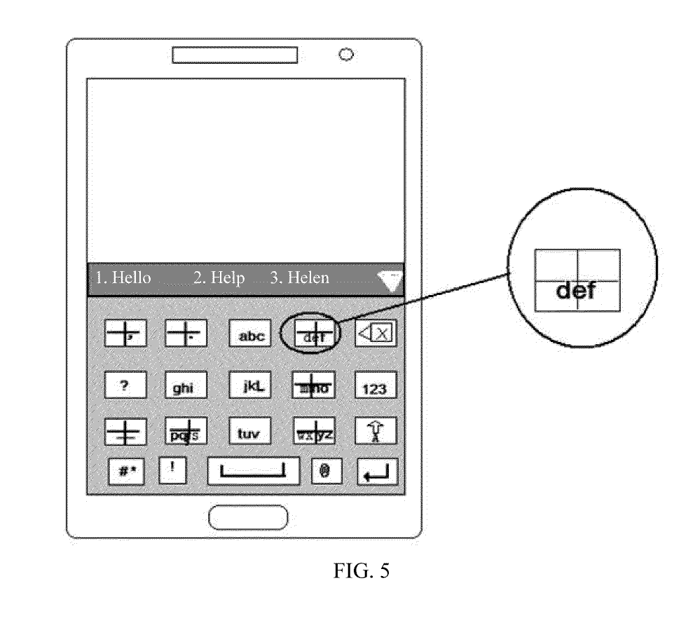

As shown in FIG. 5, each input key on a 9-key input operation interface of the intelligent terminal may be divided into four small areas: an upper left side, a lower left side, an upper right side, and a lower right side. Statistics about a probability P1 at which a lower left sub-area of a “def” key on an upper right side of the 9-key input operation interface is touched and a probability P2 at which a lower right sub-area of a “,” key on an upper left side of the 9-key input operation interface is touched are collected in a preset length of time after the user starts to enter. If the P1 is greater than or equal to the P2, it is determined that the user performs the input operation using the left hand. If the P1 is less than the P2, it is determined that the user performs the input operation using the right hand.

In addition, statistics about a probability P3 at which a left-side sub-area of a “wxyz” key on a lower right side of the 9-key input operation interface is touched and a probability P4 at which a right-side sub-area of a “pqrs” key on a lower left side of the input operation interface is touched may also be collected. If the P3 is greater than or equal to the P4, it is determined that the user performs the input operation using the left hand. If the P3 is less than the P4, it is determined that the user performs the input operation using the right hand.

Likewise, if a time interval between a key press and a next key press exceeds a preset time threshold, for example, 30 seconds, the next key press is used as a first key press in another preset length of time. Preferably, for more convenient use of a 9-key input method by the user, an arrangement sequence of a candidate word is adjusted only once in one preset length of time.

Therefore, according to the method for displaying an input operation interface of an intelligent terminal in this embodiment, whether a user performs an input operation using a right hand or a left hand is determined on a basis of a probability at which a sub-area of a key is touched, and then a sequence of input keys on the input operation interface is adjusted according to a result of determining, such that the user can easily extend a finger of the user on a large screen, which greatly increases an input speed of the user and improves user experience.

### Embodiment 4

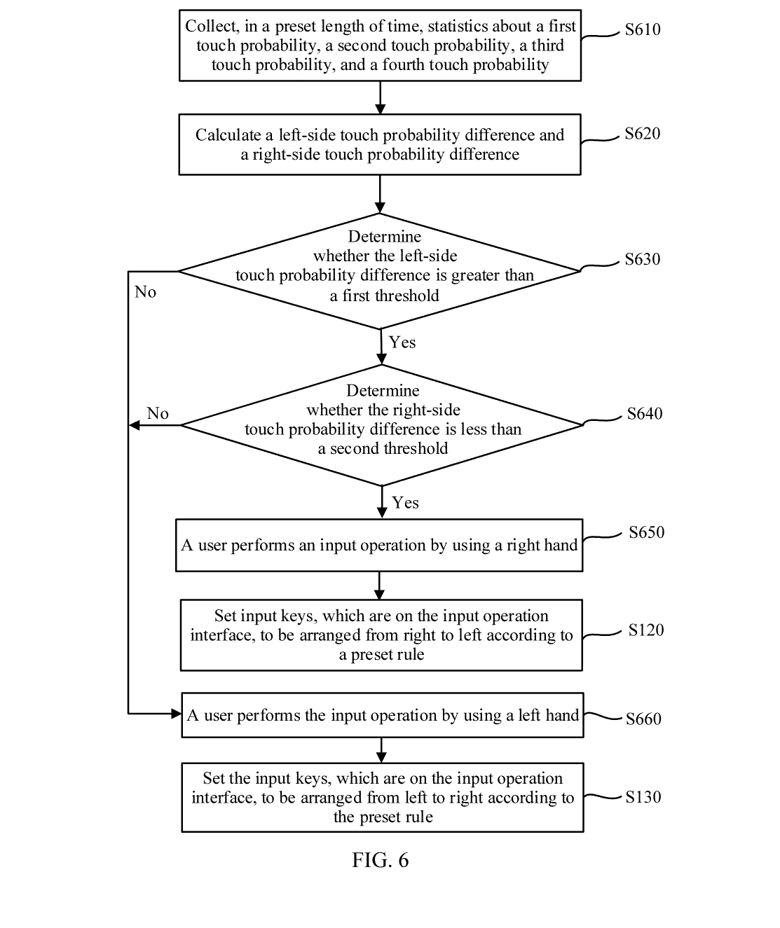

FIG. 6 is a flowchart of a method for displaying an input operation interface of an intelligent terminal according to still another embodiment of the present disclosure. A component in FIG. 6 that has a same reference numeral as that in FIG. 1 has a same function. For brevity, a detailed description of these components is omitted.

As shown in FIG. 6, a main difference between the method for displaying an input operation interface of an intelligent terminal shown in FIG. 6 and the method for displaying an input operation interface of an intelligent terminal shown in FIG. 1 is that, in a possible implementation manner, operation steps of step S110 in Embodiment 1 may further be the following steps.

S610. Collect, in a preset length of time, statistics about a first touch probability, a second touch probability, a third touch probability, and a fourth touch probability. In a possible implementation manner, the first touch probability may indicate an average value of a probability at which right-side sub-areas of at least two keys on a left side of the input operation interface are touched, the second touch probability may indicate an average value of a probability at which left-side sub-areas of at least two keys on the left side are touched, the third touch probability may indicate an average value of a probability at which right-side sub-areas of at least two keys on a right side of the input operation interface are touched, and the fourth touch probability may indicate an average value of a probability at which left-side sub-areas of at least two keys on the right side are touched.

S620. Calculate a left-side touch probability difference and a right-side touch probability difference. In a possible implementation manner, the left-side touch probability difference may equal a value obtained by subtracting the second touch probability from the first touch probability, and the right-side touch probability difference may equal a value obtained by subtracting the fourth touch probability from the third touch probability.

S630. Determine whether the left-side touch probability difference is greater than or equal to a first threshold.

S640. If the left-side touch probability difference is greater than or equal to the first threshold, determine whether the right-side touch probability difference is less than a second threshold.

S650. If the right-side touch probability difference is less than the second threshold, determine that a user performs an input operation using a right hand.

S660. If the left-side touch probability difference is less than the first threshold, or the left-side touch probability difference is greater than or equal to the first threshold and the right-side touch probability difference is greater than or equal to the second threshold, determine that the user performs the input operation using a left hand.

Therefore, according to the method for displaying an input operation interface of an intelligent terminal in this embodiment, whether a user performs an input operation using a right hand or a left hand is determined on a basis of a probability at which a sub-area of a key is touched, and then a sequence of input keys on the input operation interface is adjusted according to a result of determining, such that the user can easily extend a finger of the user on a large screen, which greatly increases an input speed of the user and improves user experience.

It should be noted that, although whether the user performs the input operation using the right hand or the left hand is described in the foregoing examples on a basis of the touch time interval of the key and on a basis of the probability at which the sub-area of the key is touched, a person skilled in the art should understand that the present disclosure is not limited thereto. All manners in which whether the user performs the input operation using the right hand or the left hand is determined by detecting a touch action and/or a tapping action performed by a finger of the user on the input operation interface of a terminal device, and input keys are adjusted to a corresponding side according to a result of determining shall fall within the scope of the present disclosure.

### Embodiment 5

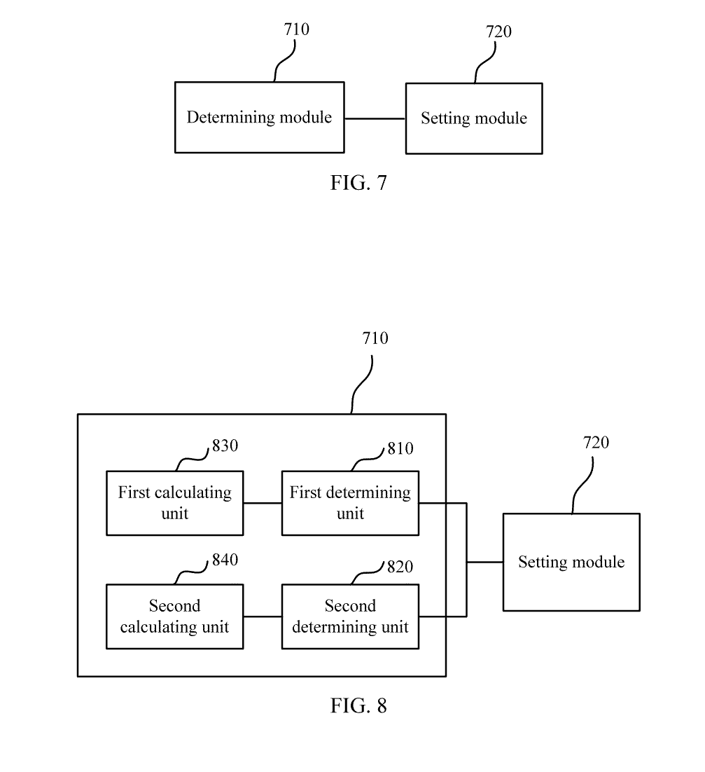

FIG. 7 is a structural block diagram of an intelligent terminal according to an embodiment of the present disclosure. As shown in FIG. 7, the intelligent terminal includes a determining module 710 and a setting module 720. The determining module 710 is configured to determine whether a user performs an input operation on an input operation interface of the intelligent terminal using a right hand or a left hand. The setting module 720 is connected to the determining module 710 and configured to, if a result of determining is that the user performs the input operation using the right hand, set input keys, which are on the input operation interface, to be arranged from right to left according to a preset rule; and if a result of determining is that the user performs the input operation using the left hand, set the input keys, which are on the input operation interface, to be arranged from left to right according to the preset rule.

In a possible implementation manner, the input keys may include at least one of the following: a candidate word key, a punctuation mark key, a numeric key, and a regular key.

In a possible implementation manner, the preset rule may include at least one of the following: a probability of use, a user preference, and network term frequency.

In a possible implementation manner, as shown in FIG. 8, the determining module 710 may include a first determining unit 810 or a second determining unit 820. The first determining unit 810 is configured to determine, on a basis of a touch time interval of a key, whether the user performs the input operation using the right hand or the left hand, where the key is located on the input operation interface, and the touch time interval of the key indicates a time interval between a previous touch and a current touch of the key. The second determining unit 820 is configured to determine, on a basis of a probability at which a sub-area of the key is touched, whether the user performs the input operation using the right hand or the left hand, where the sub-area indicates a part on an upper left side, a lower left side, an upper right side, a lower right side, a left side, or a right side of the key, and the probability at which the sub-area of the key is touched indicates a proportion of a quantity of times the sub-area is touched in a total quantity of times the key is touched.

In a possible implementation manner, the determining module 710 may further include a first calculating unit 830 connected to the first determining unit 810. The first calculating unit 830 is configured to collect, in a preset length of time, statistics about a first touch time interval and a second touch time interval, where the first touch time interval indicates an average value of a touch time interval of at least one key on a left side of the input operation interface, and the second touch time interval indicates an average value of a touch time interval of at least one key on a right side of the input operation interface. The first determining unit 810 is configured to compare the first touch time interval with the second touch time interval; if the first touch time interval is less than the second touch time interval, determine that the user performs the input operation using the left hand; and if the first touch time interval is greater than or equal to the second touch time interval, determine that the user performs the input operation using the right hand.

In a possible implementation manner, the determining module 710 may further include a second calculating unit 840 connected to the second determining unit 820. The second calculating unit 840 is configured to collect, in a preset length of time, statistics about a first touch probability and a second touch probability, where the first touch probability indicates a probability at which a lower left sub-area of a key on an upper right side of the input operation interface is touched, and the second touch probability indicates a probability at which a lower right sub-area of a key on an upper left side of the input operation interface is touched. The second determining unit 820 is configured to compare the first touch probability with the second touch probability; if the first touch probability is greater than or equal to the second touch probability, determine that the user performs the input operation using the left hand; and if the first touch probability is less than the second touch probability, determine that the user performs the input operation using the right hand.

In a possible implementation manner, the second calculating unit 840 is further configured to collect, in a preset length of time, statistics about a first touch probability and a second touch probability, where the first touch probability indicates a probability at which a left-side sub-area of a key on a lower right side of the input operation interface is touched, and the second touch probability indicates a probability at which a right-side sub-area of a key on a lower left side of the input operation interface is touched.

In a possible implementation manner, the second calculating unit 840 is further configured to collect, in a preset length of time, statistics about a first touch probability, a second touch probability, a third touch probability, and a fourth touch probability, where the first touch probability indicates an average value of a probability at which right-side sub-areas of at least two keys on a left side of the input operation interface are touched, the second touch probability indicates an average value of a probability at which left-side sub-areas of at least two keys on the left side are touched, the third touch probability indicates an average value of a probability at which right-side sub-areas of at least two keys on a right side of the input operation interface are touched, and the fourth touch probability indicates an average value of a probability at which left-side sub-areas of at least two keys on the right side are touched; and calculate a left-side touch probability difference and a right-side touch probability difference, where the left-side touch probability difference equals a value obtained by subtracting the second touch probability from the first touch probability, and the right-side touch probability difference equals a value obtained by subtracting the fourth touch probability from the third touch probability. The second determining unit 820 is configured to compare the left-side touch probability difference with a first threshold, and the right-side touch probability difference with a second threshold; and if the left-side touch probability difference is greater than or equal to the first threshold and the right-side touch probability difference is less than the second threshold, determine that the user performs the input operation using the right hand.

According to the intelligent terminal in this embodiment, a determining module determines whether a user performs an input operation on an input operation interface of the intelligent terminal using a right hand or a left hand, and then a setting module adjusts a sequence of input keys on the input operation interface on a basis of a result of determining, such that the user can easily extend a finger of the user on a large screen, which greatly increases an input speed of the user and improves user experience.

### Embodiment 6

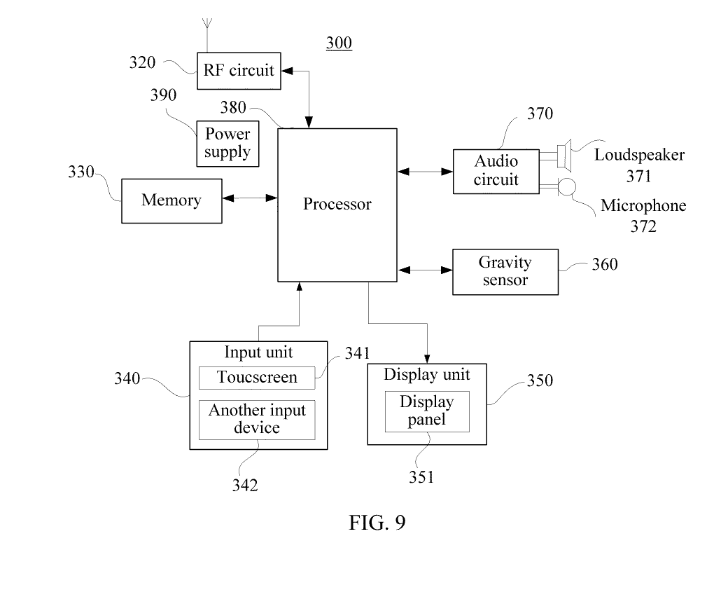

FIG. 9 is a schematic structural diagram of an intelligent terminal according to an embodiment of the present disclosure. The intelligent terminal provided in this embodiment of the present disclosure may be configured to perform the methods for implementing the embodiments of the present disclosure shown in FIG. 1 to FIG. 6. For ease of description, only a part related to this embodiment of the present disclosure is illustrated. For technical details that are not disclosed, reference may be made to the embodiments of the present disclosure shown in FIG. 1 to FIG. 6.

The intelligent terminal may be a terminal device that has a touch keyboard for input, such as a mobile phone, a tablet computer, a notebook computer, an ultra-mobile personal computer (UMPC), a netbook, or a personal digital assistant (PDA). In this embodiment of the present disclosure, it is assumed that the intelligent terminal is a mobile phone. FIG. 9 is a structural block diagram of a part of a mobile phone 300 related to the embodiments of the present disclosure.

As shown in FIG. 9, the mobile phone 300 includes parts such as a radio frequency (RF) circuit 320, a memory 330, an input unit 340, a display unit 350, a gravity sensor 360, an audio circuit 370, a processor 380, and a power supply 390. A person skilled in the art may understand that a structure of the mobile phone shown in FIG. 9 constitutes no limitation on the mobile phone, and instead the mobile phone may include more or fewer parts than those shown in FIG. 9, or a combination of some parts, or parts disposed differently.

With reference to FIG. 9, the following describes each constituent part of the mobile phone 300.

The RF circuit 320 may be configured to receive and send a signal in an information receiving or sending process or a call process, and in particular, after receiving downlink information of a base station, send the downlink information to the processor 380 for processing; and in addition, send uplink data to the base station. Generally, the RF circuit includes but is not limited to an antenna, at least one amplifier, a transceiver, a coupler, a low noise amplifier (LNA), a duplexer, and the like. In addition, the RF circuit 320 may further communicate with a network and another device using radio communications. The radio communications may be performed using any communications standard or protocol, including but not being limited to a Global System of Mobile Communications (GSM), a General Packet Radio Service (GPRS), a Code Division Multiple Access (CDMA), a Wideband Code Division Multiple Access (WCDMA), a Long Term Evolution (LTE), an Institute of Electrical and Electronics Engineers (IEEE) 802.11 wireless local area network communications protocol, a Bluetooth® communications protocol, and the like.

The memory 330 may be configured to store a software program and a software module, and the processor 380 executes various functional applications and data processing of the mobile phone 300 by running the software program and the software module that are stored in the memory 330. The memory 330 may mainly include a program storing area and a data storing area, where the program storing area may store an operating system, an application program required by at least one function (such as an audio playing function or an video playing function), and the like; and the data storing area may store data (such as audio data, image data, or a phonebook) created according to use of the mobile phone 300, and the like. In addition, the memory 330 may include a high-speed random access memory, and may further include a nonvolatile memory, for example, at least one magnetic disk storage device, a flash memory device, or another volatile solid-state storage device.

The input unit 340 may be configured to receive input numeric or character information, and generate signal input related to a user setting and function control of the mobile phone 300. The input unit 340 may include a touchscreen 341 and another input device 342. The touchscreen 341, also referred to as a touch panel, may collect a user's touch operation (such as an operation that the user performs on the touchscreen 341 or near the touchscreen 341 using a finger, a stylus, or any other suitable object or accessory) on or near the touchscreen, and drives a corresponding connected apparatus according to a preset program. Optionally, the touchscreen 341 may include two parts: a touch detection apparatus and a touch controller. The touch detection apparatus detects a touch orientation of a user, detects a signal generated by a touch operation, and sends the signal to the touch controller. The touch controller receives touch information from the touch detection apparatus, converts the touch information into touch coordinates, and sends the touch coordinates to the processor 380; and the touch controller can also receive and execute a command sent from the processor 380. In addition, the touchscreen 341 may be implemented in multiple forms, such as a resistive form, a capacitive form, an infrared form, and a surface acoustic wave form. In addition to the touchscreen 341, the input unit 340 may further include the another input device 342. The another input device 342 may include but is not limited to one or more of: a physical keyboard, a function key (such as a volume control key or a power on/off key), a trackball, a mouse, a joystick, and the like.

The display unit 350 may be configured to display information entered by the user or information provided for the user, and various menus of the mobile phone 300. The display unit 350 may include a display panel 351. Optionally, the display panel 351 may be configured in a form of a liquid crystal display (LCD), an organic light emitting diode (OLED), and the like. Further, the touchscreen 341 may cover the display panel 351. When the touchscreen 341 detects a touch operation on or near the touchscreen 341, the touchscreen 341 sends a signal to the processor 380 to determine a type of the touch event. Then the processor 380 provides corresponding visual output on the display panel 351 according to the type of the touch event. In FIG. 3, the touchscreen 341 and the display panel 351 are used as two independent parts to implement input and output functions of the mobile phone 300. However, in some embodiments, the touchscreen 341 and the display panel 351 may be integrated to implement the input and output functions of the mobile phone 300.

The gravity sensor 360 may detect a value of acceleration of the mobile phone in each direction (generally, three axes); when the mobile phone stays still, may detect a value and a direction of gravity; and may be configured in an application that recognizes a mobile phone posture (such as screen switching between portrait and landscape modes, a related game, and magnetometer posture calibration), a function related to vibration recognition (such as a pedometer and knocking), and the like.

The mobile phone 300 may further include another sensor, such as an optical sensor. The optical sensor may include an ambient light sensor and a proximity sensor. The ambient light sensor may adjust brightness of the display panel 351 according to brightness of ambient light. The proximity sensor may detect whether an object moves closer to or touches the mobile phone 300; and when the mobile phone 300 moves to an ear, the proximity sensor may close the display panel 351 and/or backlight. The mobile phone 300 may be further configured with other sensors, such as a gyroscope, a barometer, a hygrometer, a thermometer, and an infrared sensor, which are not described in detail herein again.

The audio circuit 370, a loudspeaker 371, and a microphone 372 may provide an audio interface between the user and the mobile phone 300. The audio circuit 370 may transmit a received electrical signal converted from audio data to the loudspeaker 371, and the loudspeaker 371 converts the electrical signal into an audio signal for output. In another aspect, the microphone 372 converts a collected audio signal into an electrical signal. The audio circuit 370 receives the electrical signal, converts the electrical signal into audio data, and outputs the audio data to the RF circuit 320 to send the audio data to, for example, another mobile phone, or outputs the audio data to the memory 330 for further processing.

The processor 380 is a control center of the mobile phone 300, and uses various interfaces and lines to connect parts of the entire mobile phone 300. By running or executing the software program and/or the software module that are/is stored in the memory 330 and invoking data stored in the memory 330, the processor 380 executes various functional applications of the mobile phone 300 and processes data, so as to perform overall monitoring on the mobile phone 300. Optionally, the processor 380 may include one or more processing units. Preferably, the processor 380 may integrate an application processor and a modulation and demodulation processor, where the application processor mainly processes the operating system, a user interface, an application program, and the like, and the modulation and demodulation processor mainly processes wireless communications. It may be understood that, the processor 380 may also not integrate the modulation and demodulation processor.

The mobile phone 300 further includes the power supply 390 (for example, a battery) that supplies power to each part. Preferably, the power supply 390 may be logically connected to the processor 380 using a power supply management system, such that functions such as charging, discharging, and power consumption management are implemented using the power supply management system.

The mobile phone 300 may further include a wireless fidelity (WiFi) module, a Bluetooth® module, and the like that are not shown in FIG. 9, and details are not described herein again.

In this embodiment of the present disclosure, the memory 330 is further configured to store code of a program that includes a computer operation instruction. The program may be configured to determine whether a user performs an input operation on an input operation interface of the intelligent terminal using a right hand or a left hand; if a result of determining is that the user performs the input operation using the right hand, set input keys, which are on the input operation interface, to be arranged from right to left according to a preset rule; and if a result of determining is that the user performs the input operation using the left hand, set the input keys, which are on the input operation interface, to be arranged from left to right according to the preset rule. The input keys may include at least one of the following: a candidate word key, a punctuation mark key, a numeric key, and a regular key. The preset rule may include at least one of the following: a probability of use, a user preference, and network term frequency.

In a possible implementation manner, the program may be further configured to determine, on a basis of a touch time interval of a key, whether the user performs the input operation using the right hand or the left hand, where the key is located on the input operation interface, and the touch time interval of the key indicates a time interval between a previous touch and a current touch of the key.

In a possible implementation manner, the program may be further configured to collect, in a preset length of time, statistics about a first touch time interval and a second touch time interval, where the first touch time interval indicates an average value of a touch time interval of at least one key on a left side of the input operation interface, and the second touch time interval indicates an average value of a touch time interval of at least one key on a right side of the input operation interface; if the first touch time interval is less than the second touch time interval, determine that the user performs the input operation using the left hand; and if the first touch time interval is greater than or equal to the second touch time interval, determine that the user performs the input operation using the right hand.

In a possible implementation manner, the program may be further configured to determine, on a basis of a probability at which a sub-area of a key is touched, whether the user performs the input operation using the right hand or the left hand, where the key is located on the input operation interface, the sub-area indicates a part on an upper left side, a lower left side, an upper right side, a lower right side, a left side, or a right side of the key, and the probability at which the sub-area of the key is touched indicates a proportion of a quantity of times the sub-area is touched in a total quantity of times the key is touched.

In a possible implementation manner, the program may be further configured to collect, in a preset length of time, statistics about a first touch probability and a second touch probability, where the first touch probability indicates a probability at which a lower left sub-area of a key on an upper right side of the input operation interface is touched, and the second touch probability indicates a probability at which a lower right sub-area of a key on an upper left side of the input operation interface is touched; if the first touch probability is greater than or equal to the second touch probability, determine that the user performs the input operation using the left hand; and if the first touch probability is less than the second touch probability, determine that the user performs the input operation using the right hand.

In a possible implementation manner, the program may be further configured to collect, in a preset length of time, statistics about a first touch probability and a second touch probability, where the first touch probability indicates a probability at which a left-side sub-area of a key on a lower right side of the input operation interface is touched, and the second touch probability indicates a probability at which a right-side sub-area of a key on a lower left side of the input operation interface is touched; if the first touch probability is greater than or equal to the second touch probability, determine that the user performs the input operation using the left hand; and if the first touch probability is less than the second touch probability, determine that the user performs the input operation using the right hand.

In a possible implementation manner, the program is further configured to collect, in a preset length of time, statistics about a first touch probability, a second touch probability, a third touch probability, and a fourth touch probability, where the first touch probability indicates an average value of a probability at which right-side sub-areas of at least two keys on a left side of the input operation interface are touched, the second touch probability indicates an average value of a probability at which left-side sub-areas of at least two keys on the left side are touched, the third touch probability indicates an average value of a probability at which right-side sub-areas of at least two keys on a right side of the input operation interface are touched, and the fourth touch probability indicates an average value of a probability at which left-side sub-areas of at least two keys on the right side are touched; calculate a left-side touch probability difference and a right-side touch probability difference, where the left-side touch probability difference equals a value obtained by subtracting the second touch probability from the first touch probability, and the right-side touch probability difference equals a value obtained by subtracting the fourth touch probability from the third touch probability; and if the left-side touch probability difference is greater than or equal to a first threshold and the right-side touch probability difference is less than a second threshold, determine that the user performs the input operation using the right hand.

In short, the foregoing descriptions are merely exemplary embodiments of the present disclosure, but are not intended to limit the protection scope of the present disclosure. Any modification, equivalent replacement, and improvement made without departing from the spirit and principle of the present disclosure shall fall within the protection scope of the present disclosure.

What is claimed is:

1. A method for displaying an input operation interface of an intelligent terminal, comprising:
determining whether a user performs an input operation on the input operation interface of the intelligent terminal using a right hand or a left hand;
setting input keys, which are on the input operation interface, to be arranged from right to left according to a preset rule, when a result of determining is that the user performs the input operation using the right hand; and
setting the input keys, which are on the input operation interface, to be arranged from left to right according to the preset rule, when a result of determining is that the user performs the input operation using the left hand.

2. The method according to claim 1, wherein determining whether the user performs the input operation on the input operation interface of the intelligent terminal using the right hand or the left hand comprises determining, on a basis of a touch time interval of a key, whether the user performs the input operation using the right hand or the left hand, wherein the key is located on the input operation interface, and wherein the touch time interval of the key indicates a time interval between a previous touch and a current touch of the key.

3. The method according to claim 2, wherein determining, on the basis of the touch time interval of the key, whether the user performs the input operation using the right hand or the left hand comprises:
collecting, in a preset length of time, statistics about a first touch time interval and a second touch time interval, wherein the first touch time interval indicates an average value of a touch time interval of at least one key on a left side of the input operation interface, and wherein the second touch time interval indicates an average value of a touch time interval of at least one key on a right side of the input operation interface;
determining that the user performs the input operation using the left hand, when the first touch time interval is less than the second touch time interval; and
determining that the user performs the input operation using the right hand, when the first touch time interval is greater than or equal to the second touch time interval.

4. The method according to claim 1, wherein determining whether the user performs the input operation on the input operation interface of the intelligent terminal using the right hand or the left hand comprises determining, on a basis of a probability at which a sub-area of a key is touched, whether the user performs the input operation using the right hand or the left hand, wherein the key is located on the input operation interface, wherein the sub-area indicates a part on an upper left side, a lower left side, an upper right side, a lower right side, a left side, or a right side of the key, and wherein the probability at which the sub-area of the key is touched indicates a proportion of a quantity of times the sub-area is touched in a total quantity of times the key is touched.

5. The method according to claim 4, wherein determining, on the basis of the probability at which the sub-area of the key is touched, whether the user performs the input operation using the right hand or the left hand comprises:
collecting, in a preset length of time, statistics about a first touch probability and a second touch probability, wherein the first touch probability indicates a probability at which a lower left sub-area of a key on an upper right side of the input operation interface is touched, and wherein the second touch probability indicates a probability at which a lower right sub-area of a key on an upper left side of the input operation interface is touched;
determining that the user performs the input operation using the left hand, when the first touch probability is greater than or equal to the second touch probability; and
determining that the user performs the input operation using the right hand, when the first touch probability is less than the second touch probability.

6. The method according to claim 4, wherein determining, on the basis of the probability at which the sub-area of the key is touched, whether the user performs the input operation using the right hand or the left hand comprises:
collecting, in a preset length of time, statistics about a first touch probability and a second touch probability, wherein the first touch probability indicates a probability at which a left-side sub-area of a key on a lower right side of the input operation interface is touched, and wherein the second touch probability indicates a probability at which a right-side sub-area of a key on a lower left side of the input operation interface is touched;
determining that the user performs the input operation using the left hand, when the first touch probability is greater than or equal to the second touch probability; and
determining that the user performs the input operation using the right hand, when the first touch probability is less than the second touch probability.

7. The method according to claim 4, wherein determining, on the basis of the probability at which the sub-area of the key is touched, whether the user performs the input operation using the right hand or the left hand comprises:
collecting, in a preset length of time, statistics about a first touch probability, a second touch probability, a third touch probability, and a fourth touch probability, wherein the first touch probability indicates an average value of a probability at which right-side sub-areas of at least two keys on a left side of the input operation interface are touched, wherein the second touch probability indicates an average value of a probability at which left-side sub-areas of at least two keys on the left side are touched, wherein the third touch probability indicates an average value of a probability at which right-side sub-areas of at least two keys on a right side of the input operation interface are touched, and wherein the fourth touch probability indicates an average value of a probability at which left-side sub-areas of at least two keys on the right side are touched;
calculating a left-side touch probability difference and a right-side touch probability difference, wherein the left-side touch probability difference equals a value obtained by subtracting the second touch probability from the first touch probability, and wherein the right-side touch probability difference equals a value obtained by subtracting the fourth touch probability from the third touch probability; and
determining that the user performs the input operation using the right hand, when the left-side touch probability difference is greater than or equal to a first threshold and the right-side touch probability difference is less than a second threshold.

8. The method according to claim 1, wherein the input keys comprise at least one of a candidate word key, a punctuation mark key, a numeric key, and a regular key.

9. The method according to claim 1, wherein the preset rule comprises at least one a probability of use, a user preference, and network term frequency.

10. An intelligent terminal, comprising:
a determining module configured to determine whether a user performs an input operation on an input operation interface of the intelligent terminal using a right hand or a left hand; and
a setting module connected to the determining module and configured to:
set input keys, which are on the input operation interface, to be arranged from right to left according to a preset rule, when a result of determining is that the user performs the input operation using the right hand; and
set the input keys, which are on the input operation interface, to be arranged from left to right according to the preset rule, when a result of determining is that the user performs the input operation using the left hand.

11. The intelligent terminal according to claim 10, wherein the determining module comprises a first determining unit configured to determine, on a basis of a touch time interval of a key, whether the user performs the input operation using the right hand or the left hand, wherein the key is located on the input operation interface, and wherein the touch time interval of the key indicates a time interval between a previous touch and a current touch of the key.

12. The intelligent terminal according to claim 11, wherein the determining module further comprises a first calculating unit connected to the first determining unit, wherein the first calculating unit is configured to collect, in a preset length of time, statistics about a first touch time interval and a second touch time interval, wherein the first touch time interval indicates an average value of a touch time interval of at least one key on a left side of the input operation interface, wherein the second touch time interval indicates an average value of a touch time interval of at least one key on a right side of the input operation interface, and wherein the first determining unit is configured to:
compare the first touch time interval with the second touch time interval;
determine that the user performs the input operation using the left hand, when the first touch time interval is less than the second touch time interval; and
determine that the user performs the input operation using the right hand, when the first touch time interval is greater than or equal to the second touch time interval.

13. The intelligent terminal according to claim 10, wherein the determining module comprises a second determining unit configured to determine, on a basis of a probability at which a sub-area of a key is touched, whether the user performs the input operation using the right hand or the left hand, wherein the key is located on the input operation interface, wherein the sub-area indicates a part on an upper left side, a lower left side, an upper right side, a lower right side, a left side, or a right side of the key, and wherein the probability at which the sub-area of the key is touched indicates a proportion of a quantity of times the sub-area is touched in a total quantity of times the key is touched.

14. The intelligent terminal according to claim 13, wherein the determining module further comprises a second calculating unit connected to the second determining unit, wherein the second calculating unit is configured to collect, in a preset length of time, statistics about a first touch probability and a second touch probability, wherein the first touch probability indicates a probability at which a lower left sub-area of a key on an upper right side of the input operation interface is touched, wherein the second touch probability indicates a probability at which a lower right sub-area of a key on an upper left side of the input operation interface is touched, and wherein the second determining unit is configured to:
compare the first touch probability with the second touch probability;
determine that the user performs the input operation using the left hand, when the first touch probability is greater than or equal to the second touch probability; and
determine that the user performs the input operation using the right hand, when the first touch probability is less than the second touch probability.

15. The intelligent terminal according to claim 14, wherein the second calculating unit is further configured to collect, in a preset length of time, statistics about a first touch probability and a second touch probability, wherein the first touch probability indicates a probability at which a left-side sub-area of a key on a lower right side of the input operation interface is touched, and wherein the second touch probability indicates a probability at which a right-side sub-area of a key on a lower left side of the input operation interface is touched.

16. The intelligent terminal according to claim 14, wherein the second calculating unit is further configured to:
collect, in a preset length of time, statistics about a first touch probability, a second touch probability, a third touch probability, and a fourth touch probability, wherein the first touch probability indicates an average value of a probability at which right-side sub-areas of at least two keys on a left side of the input operation interface are touched, wherein the second touch probability indicates an average value of a probability at which left-side sub-areas of at least two keys on the left side are touched, wherein the third touch probability indicates an average value of a probability at which right-side sub-areas of at least two keys on a right side of the input operation interface are touched, and wherein the fourth touch probability indicates an average value of a probability at which left-side sub-areas of at least two keys on the right side are touched; and
calculate a left-side touch probability difference and a right-side touch probability difference, wherein the left-side touch probability difference equals a value obtained by subtracting the second touch probability from the first touch probability, and wherein the right-side touch probability difference equals a value obtained by subtracting the fourth touch probability from the third touch probability,
and wherein the second determining unit is configured to:
compare the left-side touch probability difference with a first threshold, and the right-side touch probability difference with a second threshold; and
determine that the user performs the input operation using the right hand, when the left-side touch probability difference is greater than or equal to the first threshold and the right-side touch probability difference is less than the second threshold.

17. The intelligent terminal according to claim 10, wherein the input keys comprise at least one of a candidate word key, a punctuation mark key, a numeric key, and a regular key.

18. The intelligent terminal according to claim 10, wherein the preset rule comprises at least one of a probability of use, a user preference, and network term frequency.
